(19) United States
(12) Patent Application Publication
(10) Pub. No.: US 2007/0110252 A1
(43) Pub. Date: May 17, 2007

(54) Diagnostic circuit

(76) Inventors: Anthony E. Garcia, Stevenson Ranch, CA (US); William G. Howell, Half Moon Bay, CA (US)

Correspondence Address: Owen J. Bates, 1143 Beaconsfield Road, San Jose, CA, 95121, US

(21) Appl. No.: 11/274,943

(22) Filed: Nov. 13, 2005

(51) Int. Cl. H04R 29/00; H04R 3/00

(52) U.S. Cl. 381/58; 381/111

(57) ABSTRACT

A circuit is described which enables the determination of the proper functioning of a second circuit, in particular the operation of a headphone jack or audio speakers.

### BACKGROUND OF THE INVENTION

For a number of years, health clubs and gyms have provided their patrons with various items of exercise equipment. Once aerobic exercise became popular, the gym equipment companies started to manufacture such items as treadmills, stairsteppers, elliptical trainers, and stationary bicycles. One of the focal points of aerobic exercise is to exercise 3 to 5 times a week for a minimum of 30 minutes per workout. Users of such equipment quickly became bored and looked for ways to occupy themselves while putting in their exercise time.

Some users would try to read or perhaps listen to portable radios or audiocassettes. Health club management, in an attempt to cater to this new need of their clients, would provide a series of television monitors mounted in the club. These monitors would be tuned to several different television channels so playing the audio out loud from each monitor simultaneously was not feasible. To solve this problem, the first generation systems were designed so that the corresponding audio for each television channel that was being displayed would be broadcast using short range transmitters on unused broadcast radio frequencies. Signs would be placed on each monitor informing the clientele which radio frequency was being used to transmit the audio for that television monitor. The health club members would bring in their own portable radios and tune their radio to the corresponding frequency for the particular television monitor they wanted to watch.

This system was improved by utilizing small receiver boxes with volume and channel selectors built-in. These receiver boxes would be retrofitted to the desired pieces of workout equipment. The receiver boxes also included standard head phone jacks. To utilize this version, the user would only need to bring their own headset or purchase one from the gym, which would then be plugged into the jack on the receiver box. The user could, by using the controls on the box, select the audio channel and volume desired. Typically the receiver box would display a monitor number which would be matched up with the same numbered monitor showing the television program that the user was interested in watching.

One of the weakness of these systems is the headphone jack which is typically built into the housing of the receiver box. Because of the large number of users, headphones plugs are inserted and removed from the headphone jacks many times a day. Often times, the user forgets that his headphones are plugged in and walks away from the equipment without removing the headphone plug from the headphone jack. This results the plug being yanked out of the receptacle and subjecting the headphone jack to unnecessary wear and tear. The internal contacts in the headphone jack are subject to metal fatigue and possible corrosion and at some point actually break or no longer make adequate contact with the headphone plug. In either case, the result if a non-functioning headphone jack.

There is no way for the user to know ahead of time which headphone jacks are working. The user will get on a piece of equipment, place their paraphernalia (e.g. books, magazines, water, keys, cell phone etc.) onto the equipment and then plug in their headphones. If the jack is defective the user must then gather up all his paraphernalia and move to another piece of equipment. More often than not, the user doesn't take the time to inform the club personnel that there is a problem. Therefore, the equipment remains unrepaired and waiting to frustrate a subsequent user.

When the defect finally comes to the attention of the proper person, the device typically had to be taken out of service, and a factory service representative had to be called to either replace the whole console or disassemble and re-solder a new headphone jack into the circuit. Some improvement has been made by placing the headphone jack into a user replaceable module that can be easily replaced by club personnel. Broadcast Vision and Cardio Theater both have such options for their equipment. While a replaceable module facilitates the repair of the problem, it does nothing to help identify which units are defective and need repair.

It is an object of the present invention to provide a diagnostic circuit which can identify the most common reasons for headphone jack failure and provide a clearly discernable warning to others.

It is an object of the present invention to provide the diagnostic circuit with the ability to provide a warning of the defect to a remote location by way of any electric, electronic, computer or wireless means of information transmission

It is a further object of the present invention to couple the diagnostic circuit with a replaceable headphone jack module which can be easily replaced when the diagnostic circuit has indicated a fault in the headphone jack.

It is a further object of the invention to place as many of the components of the diagnostic circuit in the console so that there are a minimum number of components in the replaceable headphone jack module in order to reduce costs of the replaceable module.

It is another object of this present invention to provide a replaceable headphone jack module which contains all of the components of the diagnostic circuit necessary to perform the diagnostic function and alert personnel to failure of the headphone jack module. Placement of all of the diagnostic circuit elements within the replaceable headphone jack module allows for easy updating or upgrading of the diagnostic circuit.

It is an object of the present invention to provide a replaceable retrofitable diagnostic headphone jack module which can be used with existing equipment by plugging into an existing headphone jack without the needed to modify any aspect of the existing equipment.

### BRIEF SUMMARY OF THE INVENTION

The present invention pertains to an electronic diagnostic circuit that is either located

a) entirely within the console,

b) partially within the console and partially within the replaceable module;

c) entirely within the replaceable module but obtaining power from the console or

d) entirely within the replaceable module including the source of power.

a. Entirely within the Console.
This embodiment is primarily intended for new devices where the diagnostic circuit can be incorporated into the overall design. However it does not preclude the option of retrofitting an existing console by adding the components needed for the diagnostic circuit within the console.

b. Partially with the Console.
Certain of the components of the diagnostic circuit, such as the operational amplifier or voltage comparators may be subject to malfunctioning at a greater rate than other components. Those components deemed to have shorter functional life can be placed in the replaceable headphone jack module so that they can be easily be replaced.

c. All Component within the Replaceable Headphone Jack Module, Except Power
In order to facilitate the complete replacement or upgrade of the diagnostic circuit, all of the active components of the diagnostic circuit can be placed within the Replaceable Headphone Jack Module. Power for the active components of the diagnostic circuit can be provided from the console to the diagnostic circuit within the Replaceable Headphone Jack Module.

d. All Components Entirely within the Replaceable Module Including a Source of Power.
It is possible to place all of the components for the diagnostic circuit in an entirely separate module including a source of power. This would be used in conjunction with existing audio sources. The separate module can be plugged into a headphone jack on the existing device. A user would then plug their headphones into the headphone jack on the separate module. By use of a separate module, wear and tear on the headphone jack in the existing equipment is almost completely eliminated because users would be using the headphone jack in the separate headphone module instead of the headphone jack in the existing equipment.
Power for the separate module can be obtained from batteries or an external standard AC to DC power module. If the diagnostic circuit detects any defects in the headphone jack on the separate module, then some form of notification can be made.
This embodiment would provide a way to reduce maintenance of existing equipment without the need for any retrofitting or modification to the existing equipment.

The diagnostic circuit will determine the proper operation of other circuits. If the diagnostic circuit determines that the other circuit is not operating within predetermined parameters an initial fault signal is generated.

Additionally, this fault signal may be provided to logic circuits which would evaluate such parameters as the length, timing and frequency of the initial fault signals and provide an end User fault signal. This use of additional logic circuits may be implemented if a particular installation, because to its location, local electromagnetic interference, 120 volt line noise or fluctuations, or the particular type of hardware, may have false positives than can be screened out by the additional use of logic circuits.

Reference to the diagnostic circuit refers to those electrical components which are added solely for the purpose of performing the diagnostic function. Though some of the diagnostic circuits make use of conductivity through the headphone jack and related elements, these elements are not considered for this purpose to be part of the diagnostic circuit because those headphone jack elements would have been present, regardless of whether there was or was not a diagnostic circuit.

### BRIEF DESCRIPTION OF SEVERAL VIEWS OF THE DRAWING

The present invention is hereinafter described in conjunction with the appended drawings, in which:

FIG. 1 shows a perspective view of the main console and the replaceable headphone module;

FIG. 2 shows an exploded view of the main console with the Replaceable Headphone Module and Module Cover shown removed from the Main Console for viewing purposes;

FIG. 3 is block diagram showing the main features of the diagnostic headphone jack circuit;

FIG. 4 is a block and detailed schematic of the Headphone Switch Detection Circuit;

FIG. 5 is detailed schematic of the Current Limited DC Bias Source;

FIG. 6 is a block schematic of the DC Level Detection Circuit;

FIG. 7 is a detailed schematic of the DC Level Detection Circuit; and

FIG. 8 is a detailed circuit schematic of an alternative embodiment of the invention.

Although the Replaceable Headphone Module is shown with a mechanical connector which allows the Replaceable Headphone Module to receive the audio signal, it is within the scope of the invention that this connection can be made by wireless, optical or any other form of form of audio communications between the console and the Replaceable Headphone Module which is compatible with the diagnostic circuit.

Although the specification refers to headphone jacks (and corresponding plugs) which have the industry typical configuration of being round and 2.5 or 3.5 mm in diameter with two electrically isolated conductors along the length of the jack and a ground connector made by an annular contact located at the open end of the jack, any type of electrical connection which allows for the removable connection of a headphone, monaural or stereo, to a circuit is within the scope of this disclosure.

### DETAILED DESCRIPTION OF THE INVENTION

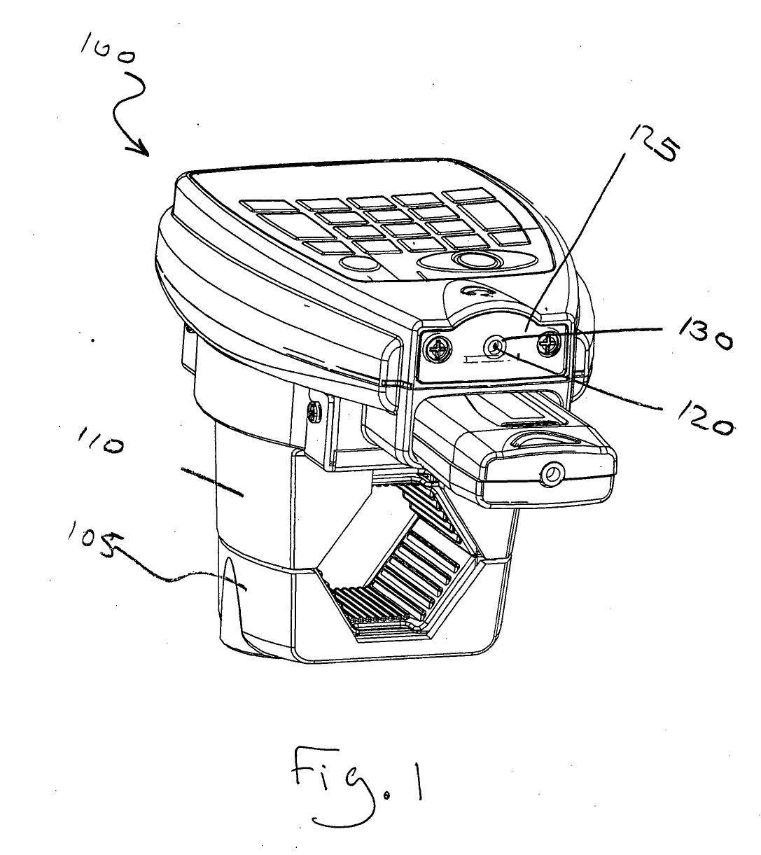

Referring now to FIG. 1, the Main Console 100 is shown with Lower Clamp 105 and Upper Clamp 110 for mounting the Main Console to a rigid support, typically part of the frame of an exercise device. Along one end of Main Console 100 is shown Module Cover 125 which attaches to the front of Main Console 100. Module Cover 125 physically retains Replaceable Headphone Jack Module 120 within the Main Console 100. Module Cover 125 contains an opening therein which permits access to Headphone Jack 130 while the Replaceable Headphone Jack Module 120 is contained within Main Console 100.

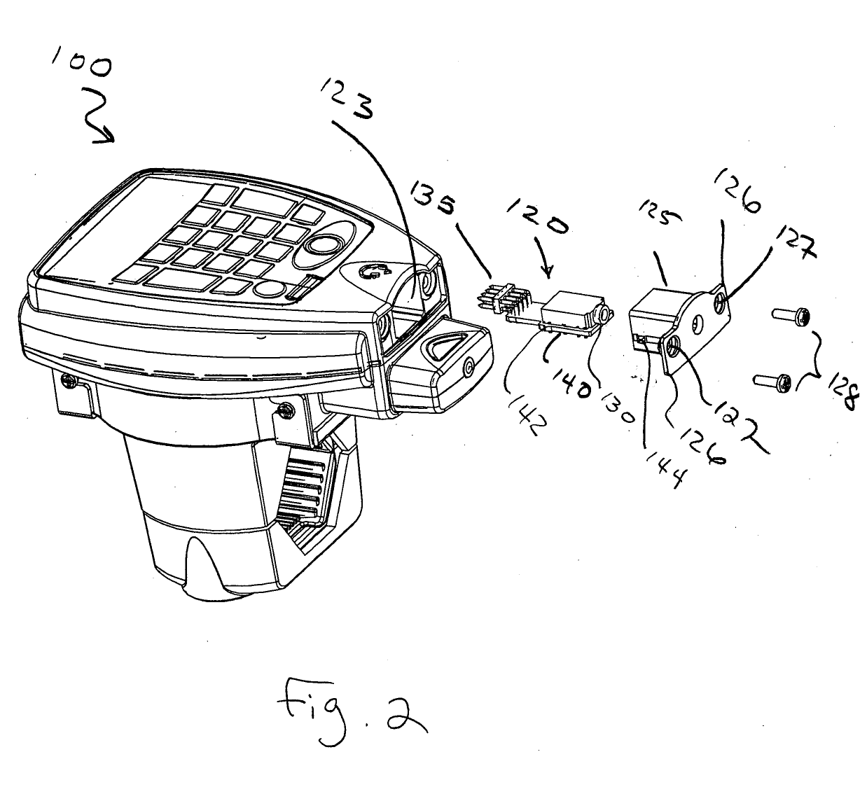

FIG. 2 shows Main Console 100 with the Replaceable Headphone Jack Module 120 and Module Cover 125 shown removed from the Main Console 100. Replaceable Headphone Jack Module 120 includes Headphone Jack 130, Circuit Board 140 and Module Connector 135. Headphone Jack 130 is adapted to physically and electrically receive a headphone plug, typically one that is 2.5 mm in diameter. Module Connector 135 is physically and electrically adapted to mate with a corresponding connector located within Main Console 100. Main Console 100 includes a Headphone Module Receiving Cavity 123 into which is disposed the Replaceable Headphone Module 120 and a portion of Module Cover 125. Module Cover 125 includes a pair of Retaining Tabs 126 which contain Mounting Holes 127. Mounting Screws 128 are positioned through Mounting Holes 127 and engaged with threaded holes in the body of Main Console 100. Circuit Board 140 includes a pair of Locking Tabs 142 located one on each side of Circuit Board 140. Locking Tabs 142 are adapted to engage a corresponding pair of Locking Notches 144, located one on each side of Module Cover 125. In this embodiment, Circuit Board

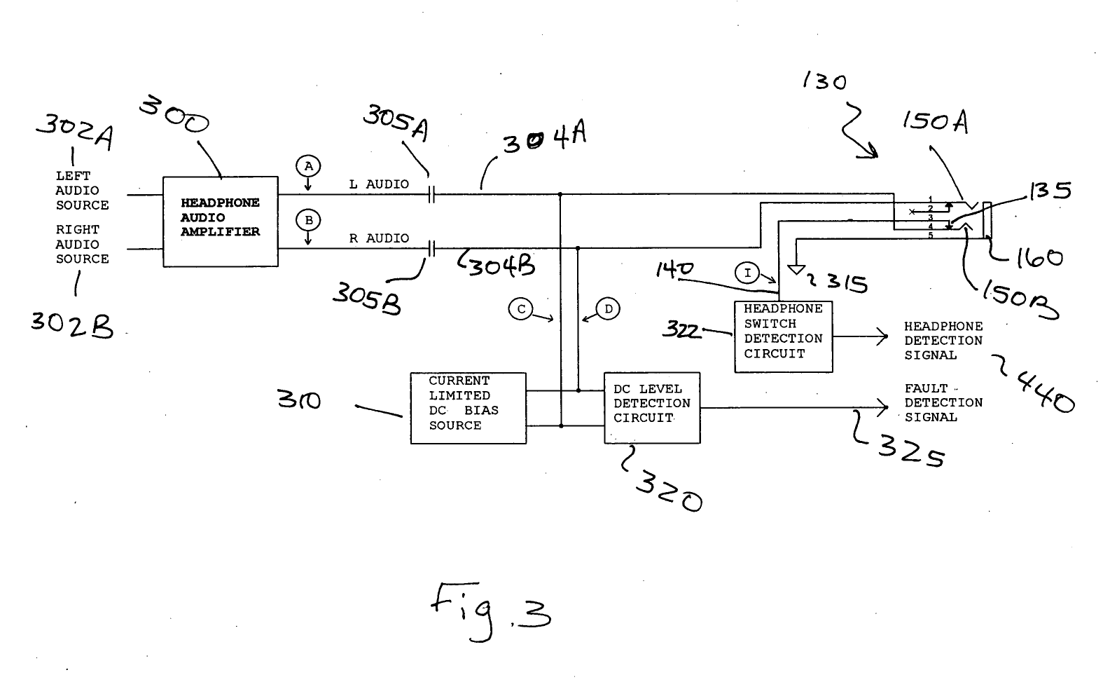

FIG. 3 shows a block schematic of the diagnostic headphone circuit. Detailed schematics for various the functions described and shown in block form in FIG. 3 shall be shown and discussed in subsequent figures provide herein. A Left Audio Source 302A and Right Audio Source 302B are provided as inputs to Headphone Amplifier 300. The output of Headphone Amplifier 300 is labeled as A and B on this and other figures presented herein. The outputs of Headphone Amplifier 300 are ultimately conducted to Headphone Jack 130.

A pair of capacitors 305A and 305 B are placed in series with the outputs of Headphone Amplifier 300. A DC Voltage is placed on the output of the Capacitors 305A and 305B at locations C and D in the schematic. DC Biased Left Audio Signal 304A and DC Biased Right Audio Signal 304B are the output of Capacitors 305A and 305B plus the applied DC bias.

The Capacitors 305A and 305B function as audio coupling and DC blocking capacitors to isolate the applied DC voltage from the Headphone Amplifier 300, to isolate the DC voltage generated by the Headphone Amplifier 300 from the rest of the circuit and to allow the audio signal to pass from the Headphone Amplifier 300 to the portion of the circuit on other other side of the blocking capacitors.

In normal operating conditions the DC voltage on each audio channel will be conducted through the Headphone Jack 130, the inserted headphones plugged into Headphone Jack 130, and back through Ground Contact 160 on Headphone Jack 130 to Circuit Ground 315.

Therefore, in the normal operating conditions just described, DC Level Detection Circuit 320 will not detect any significant DC voltage. With there being essentially zero volts on the audio channels the Headphone Fault Detection Signal 325 will not be activated. However, if there is a break in the circuit, usually due to a break in the headphone jack and occasionally due to a break in the inserted headphone set, then the DC voltage supplied by Current Limited DC Bias Source 310 will be detected by DC Level Detection Circuit 320 and Headphone Fault Detection Signal 325 will be activated.

Because the flexible contacts in Headphone Jack 130 are subject to breakage, the Headphone Jack 130 is incorporated into a Replaceable Headphone Jack Module 120 which is removably attachable to the Main Console 100. Replaceable Headphone Jack Module 120 includes Module Cover 125 which is adapted to electrically and physically mate with a corresponding jack mounted within Main Console 100. If a defect is identified in Headphone Jack 130, then the whole Replaceable Headphone Jack Module 120 can easily be removed and replaced by persons who don't have any specialized training.

Headphone Jack 130 includes Audio Signal Contacts 150A and 150B which typically make contact with the tip and ring of the headphone plug. Contact 160 is typically contacts the sleeve on headphone plug and is connected to Circuit Ground 315.

In addition a Headphone Switch 135 is incorporated into Headphone Jack 120, which connects Headphone Switch Line 140 with Audio Signal Contact 150B. If there is no headphone plug inserted into Headphone Jack 130, then Headphone Switch Line 140 makes contact with Contact 150B and conducts the DC bias voltage on DC Biased Left Audio Signal 304A (also shown as (C) in FIG. 3) to Headphone Switch Detection Circuit 322 located within the Main Console 100. When a headphone plug is inserted into Headphone Jack 130 then the contact between Headphone Switch Line 140 and Contact 150B is broken and the applied DC voltage is no longer present on Headphone Switch Line 140.

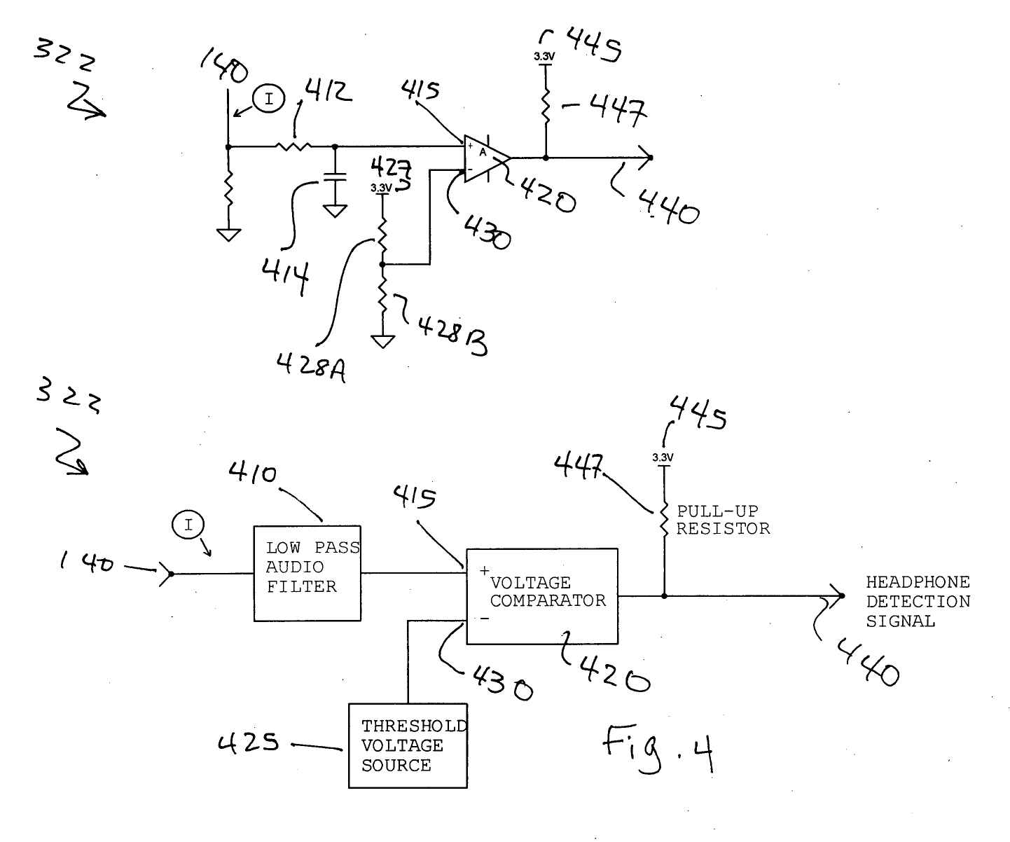

FIG. 4 depicts a block and a detailed schematic of the Headphone Switch Detection Circuit 322. Headphone Switch Line 140 (also shown as (I) in FIG. 3) passes through a Low Pass Audio Filter 410, which is comprised of Resistor 412 and Capacitor 414, and connects to the non-inverting input 415 of Voltage Comparator 420. Threshold Voltage Source 425 is connected to the Inverting Input 430 of Voltage Comparator 420. The voltage supplied to Inverting Input 430 is provided by Voltage Source 427 and Voltage Resistors 428A and 428B.

If there is no headphone plug inserted into Headphone Jack 130, then Headphone Switch 135 is closed and the voltage supplied by Current Limited DC Bias Source 310 is present at the Non-Inverting Input 415. The circuit has been designed such that the Threshold Voltage Source 425 will be slightly less than the voltage on the Non-Inverting Input 415 when there is no headphone plug inserted into Headphone Jack 130. In this circumstance, the Voltage Comparator 420 is non-conducting.

Headphone Detection Signal 440 normally provides 3.3 volts which is the voltage provided after the Voltage Source 445 passes through Pull-Up Resistor 447. As previously described, when no headphone plug is inserted into Headphone Jack 130, Voltage comparator 420 is non-conducting and there is no change to the voltage level on Headphone Detection Signal 440.

However, if there is a headphone plug inserted, then the applied DC voltage from Current Limited DC Bias Source 310 on Headphone Switch Line 140 is not present and there is a difference in the voltages present on the non-inverting and inverting inputs to Voltage Comparator 420. Thus Voltage Comparator 420 will be conducting and will short Voltage Source 445 to ground though the pull-up resistor 447 and Headphone Detection Signal 440 will be essentially zero.

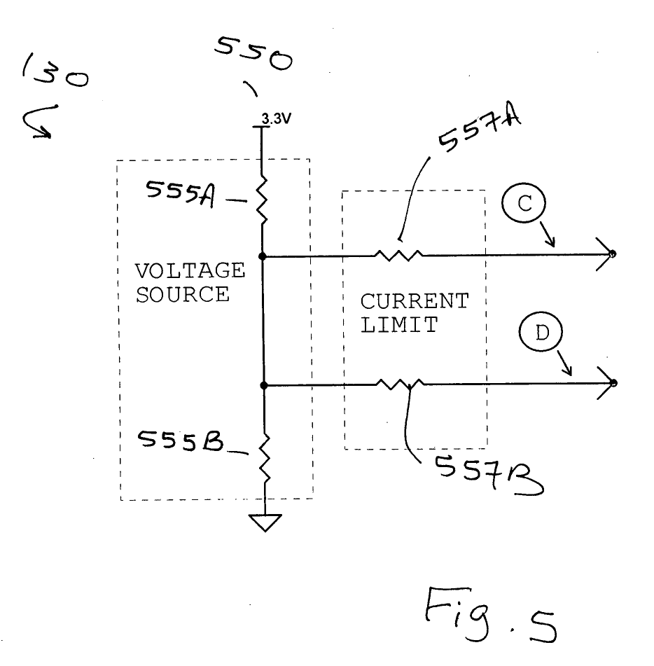

FIG. 5 depicts details of Current Limited DC Bias Source 130. Voltage Source 550 provides 3.3 volts which passes through series Resistors 555A and 555B to ground. Resistors 555A and 555B are typically 1 k ohms each. The actual voltage provided by Current Limited DC Bias Source 130 is taken at the junctions of Resistors 555A and 555B. Resistors 555A and 555B form a voltage divider network and be sized to provide the desired voltage. Two Current Limiting Resistors 557A and 557B, one each placed in series with each of the connections made to DC Biased Left Audio Signal 304A and DC Biased Right Audio Signal 304B (also shown as (C) and (D) in FIG. 3)

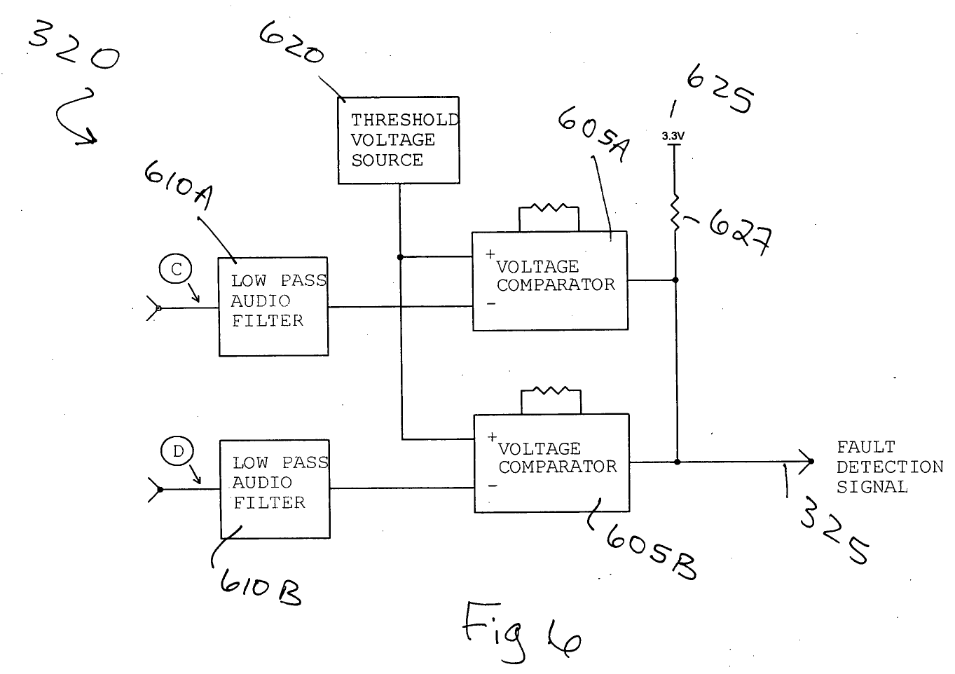

FIG. 6 depicts a block level schematic for DC Level Detection Circuit 320. The circuit is composed of two voltage comparators 605A and 605B which each monitor the DC voltage on one of the DC Biased Left and Right Audio Signals 304A and 304B. If either comparator detects a fault condition on the particular DC Biased Audio Signal it is monitoring, then Fault Detection Signal 325 is activated.

The inputs (C and D from FIG. 3 and FIG. 5) to each comparator passes through Low Pass Audio Filters 610A and 610B. These filters are provided to reduce and/or eliminate the effects of any voltage fluctuations due to the audio signal which might effect the operation of the comparators while allowing the average DC voltage from the L/R Audio+DC Bias to pass through. However, audio signals containing a high amplitude bass components may pass sufficient signals through the Low Pass Filters to effect operation of the comparators.

Each Voltage Comparator 605A and 605B looks at two voltages. The first voltage is provided by Threshold Voltage Source 620 which is designed to provide a somewhat lower voltage than the voltage level as Current Limited DC Bias Source 310. When all circuit elements are functioning properly, the DC voltage on each DC Biased Left and Right Audio Signal 304A and 304B has been shorted to ground through the Headphone Jack 130 and the headphone circuit. Since this voltage is less than the Threshold Voltage level (which is typically 1 volt) the Voltage Comparator is non-conducting.

However, if there is an open circuit due to a defect in the headphone jack, a defect in the headset that is plugged into the headphone jack or there is no headset plugged into the headphone jack, the voltage appearing on one or both of the inverting inputs of the two Comparators will be higher. Under these conditions, one or both of the comparators become conducting and provide a closed circuit from the output of the Comparators to ground.

The Fault Detection Signal 325 is connected to Voltage Source 625 through Pull-Up Resistor 627. In normal operating conditions, both Voltage Comparators 605A and 605B are non-conducting and therefore have no effect on the voltage level on Fault Detection Signal 325. However, when there is a defect in the circuit or no headset is plugged into Headphone Jack 130, one or both of Voltage Comparators 605A and 605B are conducting and short the voltage from Voltage Supply 625 to ground resulting in an essentially zero voltage level on Fault Detection Signal 325.

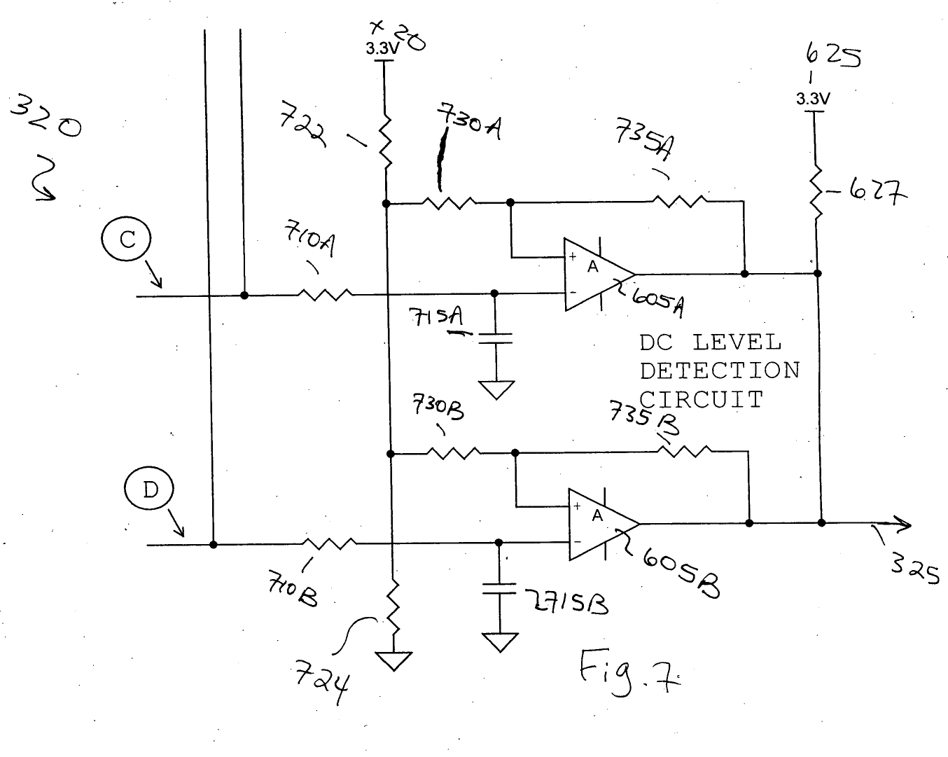

FIG. 7 shows a more detailed schematic for the DC Level Detection Circuit 320. Resistor 710A and Capacitor 715A form Low Pass Filter 610A. Resistor 710B and Capacitor 715B form Low Pass Filter 610B

Voltage Source 720, and Resistors 722 and 724 form Threshold Voltage Source 620. The voltage at the junction of Resistors 722 and 724 is connected to the non-inverting input of Comparators 605A and 605B through Resistors 730A and 730B. The Outputs 732A and 732B of each Comparator is connector to the non-inverting input through Hysteresis Resistors 735A and 735B, which prevent oscillation in the circuit. The remaining parts of the circuit have already been described.

An alternative configuration would be to provide a Fault Detection signal for each of DC Biased Left and Right Audio Signals 304A and 304B. If no headphone is plugged in, then a Fault Detection Signal would be activated for each of the Audio Left and Right Signals. Since it's not very likely that there would be an open circuit in both channels simultaneously, a Fault Detection on both channels would more likely indicate that a headphone was not plugged in. It would be possible to eliminate the circuitry needed for the Headphone Switch Detection Circuit 322.

Both Fault Detection Signals would be provided as input to a logic circuit which would make a determination that only one of the Fault Detection Signals was activated and if it met other criteria, generate an End User Fault Signal.

The following is a list of the specific components used in the circuits shown in FIGS. 3-7.

| | | | Value or |
|---|---|---|---|
| Fig. No. | Type | Ref. No. | Part No. |
| | Capacitor | 305A | 220 microfarads |
| | | 305B | 220 microfarads |
| | Resistors | 410 | 100K |
| | | 412 | 110K |
| | | 428A | 33K |
| | | 428B | 10K |
| | | 447 | 2.2K |
| | Capacitor | 414 | 0.1 microfarad |
| | Differential | 420 | LM339D |
| | Comparator | | |
| | Resistors | 555A | 1K |
| | | 555B | 1K |
| | | 557A | 1K |
| | | 557B | 1K |
| | Resistors | 710A | 10K |
| | | 710B | 10K |
| | | 722 | 10K |
| | | 724 | 1K |
| | | 730A | 10K |
| | | 730B | 10K |
| | | 735A | 1 Meg |
| | | 735B | 1 Meg |
| | | 627 | 2.2K |
| | Capacitors | 715A | 0.1 microfarads |
| | | 715B | 01. microfarads |
| | Differential | 605A | LM339D |
| | Comparators | 605B | |

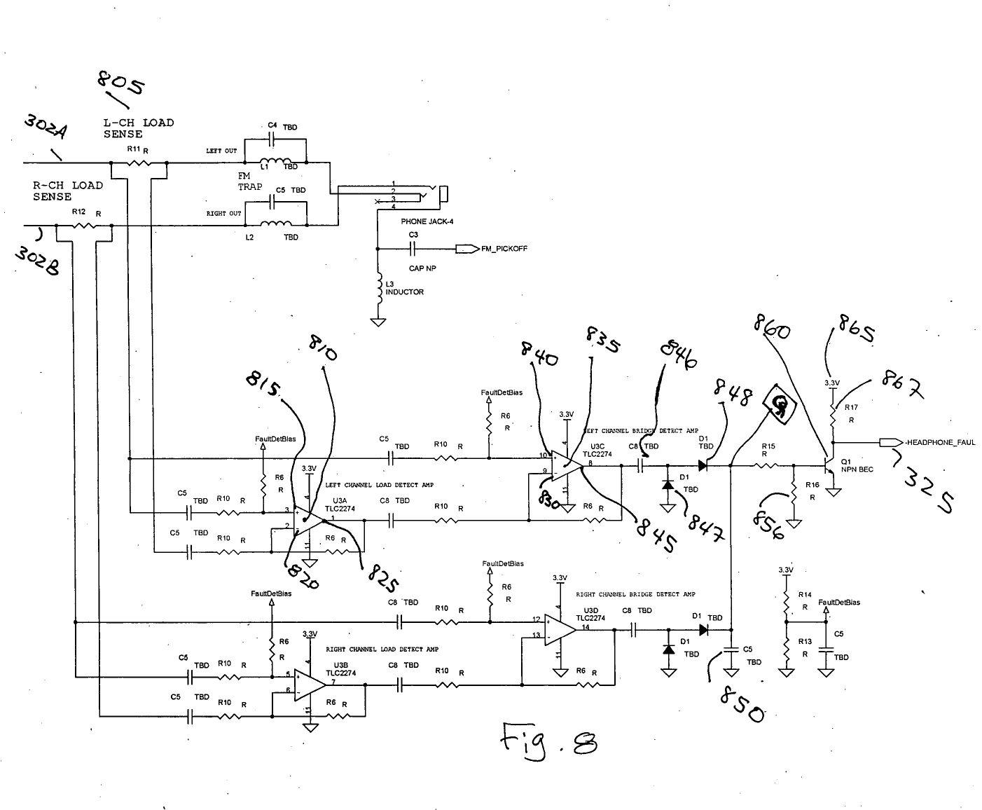

A second alternative embodiment is shown in schematic form in FIG. 8. This circuit is composed of two portions which are essentially identical up to point Q in the circuit. The following discussion will be directed to the circuit which interacts with Left Audio Source 302A. The circuit which interacts with Right Audio Source 302B is identical up to point Q. This circuit is dynamic in nature and requires an audio signal in order to detect a fault condition.

Load Sense Resistor 805 is placed in series with Left Audio Source 302A. A differential amplifier is used to read the voltage drop across Load Sense Resistor 805.

Except for an open circuit condition, when there is an audio signal source in the left channel then there will be a voltage drop across Load Sense Resistor 805. A voltage divider circuit is formed with Load Sense Resistor 805 and the impedance in the headphone that is plugged into Headphone Jack 130. Usually Load Sense Resistor 805 is 1/10 of the impedance of the headphones. So if typical headphones are 32 ohms then Load Sense Resistor 805 would be 3.2 ohms, but the actual value of Load Sense Resistor 805 can be sized for particular equipment.

Leads coming from both sides of Load Sense Resistor 805 go to Inverting Input 820 and Non-Inverting Input 815 of Operational Amplifier 810. There is voltage on Output 825 if there is a signal differential between Inverting Input 820 and Non-Inverting Input 815.

There is voltage on Output 825 only if there is current flow through Load Sense Resistor 805 which causes a signal differential between Inverting Input 820 and Non-Inverting Input 815. Output 825 is connected to Inverting Input pin 830 of Operational Amplifier 835. Non-inverting Input 840 of Operational Amplifier 835 comes from a lead just before Load Sense Resistor 805. Therefore Non-Inverting Input 840 gets the full signal of the output from the Headphone Amplifier 300, even if there is no current flow in Load Sense Resistor 805.

Operational Amplifier 810 and supporting components are designed to provide the same signal level as Non-Inverting Input 840 will get, in normal operating conditions. If the signal voltages at Non-Inverting Input 840 and Inverting Input 830 of Operational Amplifier 835 are the same then there is no signal voltage on the Output 845 of Operational Amplifier 835.

However, if there a break in Headphone Jack 130 or a break in the headset that is plugged into Headphone Jack 130, then there will be no current in Load Sense Resistor 805 which results in a difference in voltages at Inputs 840 and 830. Therefore there will an audio signal at Output 845.

Capacitor 846 and Diodes 847 and 848 form a rectifying circuit which provides DC voltage.

An identical circuit is used to monitor the current flow in Right Audio Source 302B. If there is break in the either the Left or Right Audio Source then the DC voltage that is generated by the either circuit will charge Capacitor 850. Resistor 855 limits current to the base of Transistor 860. Resistor 856 is used as a discharge path for the voltage stored in capacitor 850.

Voltage Source 865 and Resistor 867 normally provide a 3.3 voltage on Headphone Fault Signal 325. If there is no DC voltage generated by either detection circuit there will be no DC voltage developed across Capacitor 850 or on the base of Transistor 860. If there is no voltage on the base of Transistor 860 then Transistor 860 does not turn on and there is no change in the voltage appearing on Headphone Fault Signal 325. If there is a voltage developed on Capacitor 850 due to a reduction in the voltage drop across Load Sense Resistor 805, the Transistor 860 becomes conducting and shorts Voltage Source 865 to ground an causing Headphone Fault Signal 325 to become essentially zero.

In summary, signal voltage output from the Headphone Amplifier 300 is compared to the voltage drop across Load Sense Resistor 805. In normal operating conditions these two signals are in a fixed ratio and Output of 845 of Operational Amplifier 835 provides no output. However, if there is no current in Sense Resistor 805 and therefore no voltage drop (open circuit) or there is a short in the headphone jack and/or headphone (i.e. a much larger amount of current in R11), then the ratio of the two measured values will be different and there will be voltage present on Output 845 of Operational Amplifier 835 which will turn on Transistor 860 and short the Headphone Fault Detection Signal to an essentially zero voltage. This circuit is dynamic in nature and requires an audio signal to determine a fault condition. Without an audio signal present, the Headphone Fault Signal 325 will necessarily go to a non-fault indicating state (voltage remains high).

These various conditions with audio signal present are summarized in the table below.

| | Load Sense | | | Headphone Fault |
|---|---|---|---|---|
| Conditions | Resistor 805 | Output 825 | Output 845 | Detection Signal 325 |
| Normal | Normal current | Normal | No voltage because | Voltage Remains |
| | level in R11 | signal level | input 830 and Input 840 | High |
| | | | are designed to be the | |
| | | | same in normal | |
| | | | operating conditions | |
| Break in | NO CURRENT | No voltage | There is output because | Voltage drops to |
| headphone | IN R11 | | Pin 10 still sees the | essentially zero |
| jack, | | | same voltage as before, | |
| headset or | | | but now pin 9 has no | |
| headset not | | | signal present- | |
| plugged in | | | generating output and | |
| | | | turning on Q1 | |
| Short in | High current in | High signal | There is output because | Voltage drops to |
| headphone | R11 | voltage | Input 830 now has | essential zero. |
| jack or | | | higher than designed for | |
| headphone | | | voltage and Comparator | |
| | | | Operational Amplifier | |
| | | | 835 senses this disparity | |
| | | | and provides voltage on | |
| | | | Output 845, which turns | |
| | | | on Transistor 860. | |

Though the diagnostic circuit of the invention has been described as being incorporated into an entertainment module for the detection of a malfunctioning headphone jack, all embodiments of the invention described above can also be used to detect malfunctioning speakers or defects in the wiring leading to and from the speakers, particularly remotely mounted speakers.

For example, paging systems in hospitals, speakers in movie theaters or other business often have speakers mounted in a great number of locations and often mounted in auditoriums having high ceilings. Emergency notification systems such as community hurricane warning systems and industrial plant evacuation warning systems may have speakers mounted over a wide geographic area. Actual determination of the functioning of these speakers would require costly and potential dangerous physical inspection of each one. By utilizing the diagnostic circuit of the present invention, each speaker could have its own diagnostic circuit and an associated notification system. All of the notification systems could be located in one place so that it would be easy to monitor a single display to verify the functioning of all of the speakers being monitored.

While the invention has been described in conjunction with the preferred specific embodiments thereof, it is to be understood that the foregoing description as well as the example are intended to illustrate and not limit the scope of the invention. Other aspects, advantages and modifications within the scope of the invention will be apparent to those skilled in the art to which the invention pertains.

We claim:

1. A circuit for determining the proper operation of a second circuit comprising:
a first voltage source applied to the second circuit; and
a first detection means for determining the presence of said first applied test voltage on said second circuit;
a fault signal means;
wherein said first detector means activates said fault signal means if said first detector means senses that the first applied voltage source has fallen outside a predetermined range.

2. A circuit for determining the proper operation of a second circuit as described in claim 1 wherein said second circuit carries an audio signal.

3. A circuit for determining the proper operation of a second circuit as described in claim 2 further comprising a second voltage source which is attached to a second portion of the second circuit and a second detector means which detects the second voltage source applied to the second portion of the second circuit.

4. A circuit for determining the proper operation of a second circuit as described in claim 3 wherein said fault signal means is activated by a either said first detector means or said second detector means.

5. A circuit for determining the proper operation of a second circuit as described in claim 1 wherein said first detector means comprises a comparator.

6. A circuit for determining the proper operation of a second circuit as described in claim 4 wherein said first detector means and said second detector means each comprises a comparator.

7. A circuit for determining the proper operation of a second circuit as described in claim 1 wherein said fault signal means is activated when the applied voltage is above a predetermined value.

8. A circuit for determining the proper operation of a second circuit as described in claim 4 wherein said fault signal means is activated when the first voltage source is above a predetermined value as detected by said first detector or by said second detector.

9. A diagnostic circuit for determining the proper operation of an audio circuit comprising:
a testing means which applies a voltage or current to said audio circuit;
a detector means which measures said voltage or current applied by said testing means, said detector means further comprising a fault signal means;
wherein said detector means activates said fault signal means when said detector means measures a change in said voltage or said current wherein said change falls outside of a predetermined range.

10. A diagnostic circuit for determining the proper operation of an audio circuit as described in claim 9, wherein said detector means activates said fault signal means if said measured voltage is above a predetermined value.

11. An audio circuit comprising:
an audio signal source;
a testing means which applies a voltage or current to the audio signal;
a detector means which measures said voltage or current applied by said testing means, said detector means further comprising a fault signal means;
wherein said detector means activates said fault signal means when said detector means measures a change in said applied voltage or said applied current when said change falls outside of a predetermined range.

12. An audio circuit as described in claim 11 wherein said audio circuit comprises a headphone jack.

13. An audio circuit as described in claim 12 further comprising a detachable module wherein said headphone jack is disposed within said detachable module.

14. An audio circuit as described in claim 11 wherein said fault signal means is activated when said applied voltage is detected to be above a predetermined value.
